(19) United States
(12) Patent Application Publication
(10) Pub. No.: US 2026/0211140 A1
(43) Pub. Date: Jul. 23, 2026

(54) SUBSURFACE DISCONTINUITY MODELING FRAMEWORK

(71) Applicant: SCHLUMBERGER TECHNOLOGY CORPORATION, Sugar Land, TX (US)

(72) Inventor: Thomas LAVERNE, Montpellier (FR)

(21) Appl. No.: 19/142,242

(22) PCT Filed: Mar. 28, 2024
(86) PCT No.: PCT/US2024/021889

§ 371 Date: Jun. 23, 2025

Related U.S. Application Data
(60) Provisional application No. 63/492,571, filed on Mar. 28, 2023.

(51) Int. Cl. G01V 1/30

(52) U.S. Cl. CPC G01V 1/302; G01V 2210/66

(57) ABSTRACT

A method can include receiving seismic data-based interpretations for discontinuities in a subsurface geologic region; automatically assessing the interpretations, with respect to a type of action for joining individual pairs of the discontinuities, to generate ranked individual pairs of the discontinuities; and performing the type of action for joining a number of the ranked individual pairs of the discontinuities to improve accuracy of a model of the subsurface geologic region.

### RELATED APPLICATIONS

This application claims priority to and the benefit of a U.S. Provisional Application having Ser. No. 63/492,571, filed 28 Mar. 2023, which is incorporated by reference herein in its entirety.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

In oil and gas exploration, geoscientists and engineers may acquire and analyze data to identify and locate various subsurface structures (e.g., horizons, faults, geobodies, fractures, etc.) in a geologic environment. Various types of structures (e.g., stratigraphic formations) may be indicative of hydrocarbon traps or flow channels, as may be associated with one or more reservoirs (e.g., fluid reservoirs). In the field of resource extraction, enhancements to interpretation can allow for construction of a more accurate model of a subsurface region, which, in turn, may improve characterization of the subsurface region for purposes of resource extraction. Characterization of one or more subsurface regions in a geologic environment can guide, for example, performance of one or more operations (e.g., field operations, etc.). As an example, a more accurate model of a subsurface region may make a drilling operation more accurate as to a borehole's trajectory where the borehole is to have a trajectory that penetrates a reservoir, etc.

### SUMMARY

A method can include receiving seismic data-based interpretations for discontinuities in a subsurface geologic region; automatically assessing the interpretations, with respect to a type of action for joining individual pairs of the discontinuities, to generate ranked individual pairs of the discontinuities; and performing the type of action for joining a number of the ranked individual pairs of the discontinuities to improve accuracy of a model of the subsurface geologic region. A system can include a processor; a memory operatively coupled to the processor; and processor-executable instructions stored in the memory and executable to instruct the system to: receive seismic data-based interpretations for discontinuities in a subsurface geologic region; automatically assess the interpretations, with respect to a type of action for joining individual pairs of the discontinuities, to generate ranked individual pairs of the discontinuities; and perform the type of action for joining a number of the ranked individual pairs of the discontinuities to improve accuracy of a model of the subsurface geologic region. One or more computer-readable storage media can include processor-executable instructions executable by a system to instruct the system to: receive seismic data-based interpretations for discontinuities in a subsurface geologic region; automatically assess the interpretations, with respect to a type of action for joining individual pairs of the discontinuities, to generate ranked individual pairs of the discontinuities; and perform the type of action for joining a number of the ranked individual pairs of the discontinuities to improve accuracy of a model of the subsurface geologic region. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geological environment;

FIG. 2 illustrates an example of a system for implementing various workflows;

FIG. 3 illustrates examples of seismic survey techniques for seismic data acquisition for examples of subsurface geologic regions;

FIG. 4 illustrates examples of subsurface geologic regions;

FIG. 5 illustrates an example of a subsurface geologic region and examples of equipment;

FIG. 6 illustrates examples of types of actions;

FIG. 7 illustrates an example of a type of action;

FIG. 8 illustrates an example of a method and example visualizations of a subsurface discontinuity;

FIG. 9 illustrates an example of a method;

FIG. 10 illustrates an example of a method;

FIG. 11 illustrates an example of a method;

FIG. 12 illustrates an example of joined discontinuities;

FIG. 13 illustrates an example of a method;

FIG. 14 illustrates examples of plots;

FIG. 15 illustrates an example of a plot that includes ranked candidates;

FIG. 16 illustrates an example of a method and an example of a system; and

FIG. 17 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Below, various types of environments, frameworks, workflows, data acquisition techniques, field equipment, field operations, etc., are described, which may involve use of a framework or frameworks, optionally during one or more field operations.

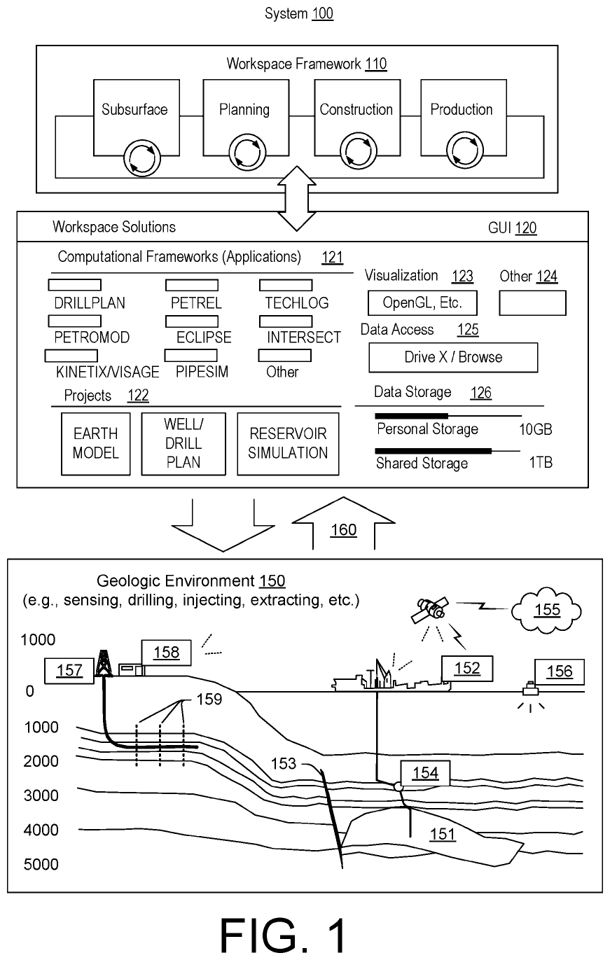

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. A geologic environment 150 may be outfitted with a variety of sensors, detectors, actuators, etc. In such an environment, various types of equipment such as, for example, equipment 152 may include communication circuitry to receive and to transmit information, optionally with respect to one or more networks 155. Such information may include information associated with downhole equipment 154, which may be equipment to acquire information, to assist with resource recovery, etc. Other equipment 156 may be located remote from a wellsite and include sensing, detecting, emitting, or other circuitry. Such equipment may include storage and communication circuitry to store and to communicate data, instructions, etc. One or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc., may exist where an assessment of such variations may assist with planning, operations, etc., to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, INTERSECT, KINETIX/VISAGE, and PIPESIM frameworks (SLB, Houston, Texas). One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). Such an environment can provide for operations that involve one or more frameworks. The DELFI environment may be referred to as the DELFI framework, which may be a framework of frameworks. The DELFI environment can include various other frameworks, which may operate using one or more types of models (e.g., simulation models, etc.).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The DRILLOPS framework, which may be included in the system 100 of FIG. 1, may execute a digital drilling plan and ensures plan adherence, while delivering goal-based automation. The DRILLOPS framework may generate activity plans automatically individual operations, whether they are monitored and/or controlled on the rig or in town. Automation may utilize data analysis and learning systems to assist and optimize tasks, such as, for example, setting ROP to drilling a stand. A preset menu of automatable drilling tasks may be rendered, and, using data analysis and models, a plan may be executed in a manner to achieve a specified goal, where, for example, measurements may be utilized for calibration. The DRILLOPS framework provides flexibility to modify and replan activities dynamically, for example, based on a live appraisal of various factors (e.g., equipment, personnel, and supplies). Well construction activities (e.g., tripping, drilling, cementing, etc.) may be continually monitored and dynamically updated using feedback from operational activities. The DRILLOPS framework may provide for various levels of automation based on planning and/or re-planning (e.g., via the DRILLPLAN framework), feedback, etc.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc. As an example, the TECHLOG framework may be coupled to one or more ML models for purposes of generation of output, training, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator with numerical solvers for prediction of dynamic behavior for various types of reservoirs and development schemes.

The INTERSECT framework provides a high-resolution reservoir simulator for simulation of geological features and quantification of uncertainties, for example, by creating production scenarios and, with the integration of precise models of the surface facilities and field operations, the INTERSECT framework can produce results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases.

The KINETIX framework provides for reservoir-centric stimulation-to-production analyses that can integrate geology, petrophysics, completion engineering, reservoir engineering, and geomechanics, for example, to provide for optimized completion and fracturing designs for a well, a pad, or a field. The KINETIX framework can be operatively coupled to and/or integrated with features of the PETREL framework (e.g., within the DELFI environment). As to the VISAGE framework it can be part of or otherwise operatively coupled to the KINETIX framework.

The VISAGE framework includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO2 disposal, etc.

As an example, the KINETIX framework can provide for analyses from 1D logs and simple geometric completions to 3D mechanical and petrophysical models coupled with the INTERSECT framework high-resolution reservoir simulator and VISAGE framework finite-element geomechanics simulator. The KINETIX framework can provide automated parallel processing using cloud platform resources and can provide for rapid assessment of well spacing, completion, and treatment design choices, enabling exploration of many scenarios in a relatively rapid manner (e.g., via provisioning of cloud platform resources). The KINETIX framework may be operatively coupled to the MANGROVE simulator (SLB, Houston, Texas), which can provide for optimization of stimulation design (e.g., stimulation treatment operations such as hydraulic fracturing) in a reservoir-centric environment.

The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). The PIPESIM simulator may be an optimizer that can optimize one or more operational scenarios at least in part via simulation of physical phenomena.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150, and feedback 160 can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

Visualization features may provide for visualization of various earth models, properties, etc., in one or more dimensions. As an example, visualization features may include one or more control features for control of equipment, which can include, for example, field equipment that can perform one or more field operations. A workflow may utilize one or more frameworks to generate information that can be utilized to control one or more types of field equipment (e.g., drilling equipment, wireline equipment, fracturing equipment, etc.).

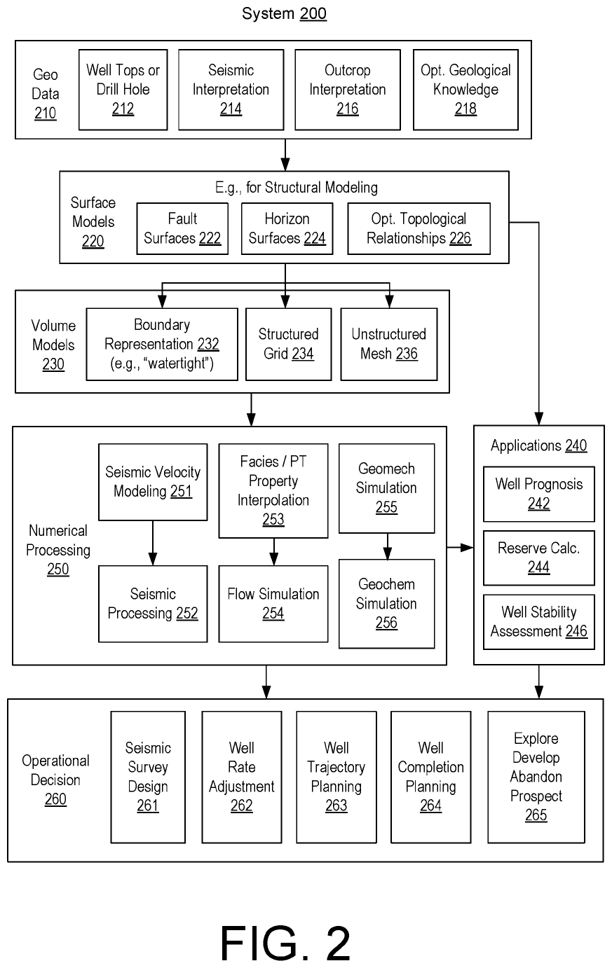

FIG. 2 shows an example of a system 200 that can be operatively coupled to one or more databases, data streams, etc. For example, one or more pieces of field equipment, laboratory equipment, computing equipment (e.g., local and/or remote), etc., can provide and/or generate data that may be utilized in the system 200.

As shown, the system 200 can include a geological/geophysical data block 210, a surface models block 220 (e.g., for one or more structural models), a volume modules block 230, an applications block 240, a numerical processing block 250 and an operational decision block 260. As shown in the example of FIG. 2, the geological/geophysical data block 210 can include data from well tops or drill holes 212, data from seismic interpretation 214, data from outcrop interpretation and optionally data from geological knowledge. As an example, the geological/geophysical data block 210 can include data from digital images, which can include digital images of cores, cuttings, cavings, outcrops, etc. As to the surface models block 220, it may provide for creation, editing, etc. of one or more surface models based on, for example, one or more of fault surfaces 222, horizon surfaces 224 and optionally topological relationships 226. As to the volume models block 230, it may provide for creation, editing, etc. of one or more volume models based on, for example, one or more of boundary representations 232 (e.g., to form a watertight model), structured grids 234 and unstructured meshes 236.

As shown in the example of FIG. 2, the system 200 may allow for implementing one or more workflows, for example, where data of the data block 210 are used to create, edit, etc. one or more surface models of the surface models block 220, which may be used to create, edit, etc. one or more volume models of the volume models block 230. As indicated in the example of FIG. 2, the surface models block 220 may provide one or more structural models, which may be input to the applications block 240. For example, such a structural model may be provided to one or more applications, optionally without performing one or more processes of the volume models block 230 (e.g., for purposes of numerical processing by the numerical processing block 250). Accordingly, the system 200 may be suitable for one or more workflows for structural modeling (e.g., optionally without performing numerical processing per the numerical processing block 250).

As to the applications block 240, it may include applications such as a well prognosis application 242, a reserve calculation application 244 and a well stability assessment application 246. As to the numerical processing block 250, it may include a process for seismic velocity modeling 251 followed by seismic processing 252, a process for facies and petrophysical property interpolation 253 followed by flow simulation 254, and a process for geomechanical simulation 255 followed by geochemical simulation 256. As indicated, as an example, a workflow may proceed from the volume models block 230 to the numerical processing block 250 and then to the applications block 240 and/or to the operational decision block 260. As another example, a workflow may proceed from the surface models block 220 to the applications block 240 and then to the operational decisions block 260 (e.g., consider an application that operates using a structural model).

In the example of FIG. 2, the operational decisions block 260 may include a seismic survey design process 261, a well rate adjustment process 252, a well trajectory planning process 263, a well completion planning process 264 and a process for one or more prospects, for example, to decide whether to explore, develop, abandon, etc. a prospect.

Referring again to the data block 210, the well tops or drill hole data 212 may include spatial localization, and optionally surface dip, of an interface between two geological formations or of a subsurface discontinuity such as a geological fault; the seismic interpretation data 214 may include a set of points, lines or surface patches interpreted from seismic reflection data, and representing interfaces between media (e.g., geological formations in which seismic wave velocity differs) or subsurface discontinuities; the outcrop interpretation data 216 may include a set of lines or points, optionally associated with measured dip, representing boundaries between geological formations or geological faults, as interpreted on the earth surface; and the geological knowledge data 218 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g., fault A truncates fault B, fault B intersects fault C, etc.).

As to the one or more boundary representations 232, they may include a numerical representation in which a subsurface model is partitioned into various closed units representing geological layers and fault blocks where an individual unit may be defined by its boundary and, optionally, by a set of internal boundaries such as fault surfaces.

As to the one or more structured grids 234, it may include a grid that partitions a volume of interest into different elementary volumes (cells), for example, that may be indexed according to a pre-defined, repeating pattern. As to the one or more unstructured meshes 236, it may include a mesh that partitions a volume of interest into different elementary volumes, for example, that may not be readily indexed following a pre-defined, repeating pattern (e.g., consider a Cartesian cube with indexes I, J, and K, along x, y, and z axes).

As to the seismic velocity modeling 251, it may include calculation of velocity of propagation of seismic waves (e.g., where seismic velocity depends on type of seismic wave and on direction of propagation of the wave). As to the seismic processing 252, it may include a set of processes allowing identification of localization of seismic reflectors in space, physical characteristics of the rocks in between these reflectors, etc.

As to the facies and petrophysical property interpolation 253, it may include an assessment of type of rocks and of their petrophysical properties (e.g., porosity, permeability), for example, optionally in areas not sampled by well logs or coring. As an example, such an interpolation may be constrained by interpretations from log and core data, and by prior geological knowledge.

As to the flow simulation 254, as an example, it may include simulation of flow of hydro-carbons in the subsurface, for example, through geological times (e.g., in the context of petroleum systems modeling, when trying to predict the presence and quality of oil in an un-drilled formation) or during the exploitation of a hydrocarbon reservoir (e.g., when some fluids are pumped from or into the reservoir).

As to geomechanical simulation 255, it may include simulation of the deformation of rocks under boundary conditions. Such a simulation may be used, for example, to assess compaction of a reservoir (e.g., associated with its depletion, when hydrocarbons are pumped from the porous and deformable rock that composes the reservoir). As an example, a geomechanical simulation may be used for a variety of purposes such as, for example, prediction of fracturing, reconstruction of the paleo-geometries of the reservoir as they were prior to tectonic deformations, etc.

As to geochemical simulation 256, such a simulation may simulate evolution of hydrocarbon formation and composition through geological history (e.g., to assess the likelihood of oil accumulation in a particular subterranean formation while exploring new prospects).

As to the various applications of the applications block 240, the well prognosis application 242 may include predicting type and characteristics of geological formations that may be encountered by a drill bit, and location where such rocks may be encountered (e.g., before a well is drilled); the reserve calculations application 244 may include assessing total amount of hydrocarbons or ore material present in a subsurface environment (e.g., and estimates of which proportion can be recovered, given a set of economic and technical constraints); and the well stability assessment application 246 may include estimating risk that a well, already drilled or to-be-drilled, will collapse or be damaged due underground stress.

As to the operational decision block 260, the seismic survey design process 261 may include deciding where to place seismic sources and receivers to optimize the coverage and quality of the collected seismic information while minimizing cost of acquisition; the well rate adjustment process 262 may include controlling injection and production well schedules and rates (e.g., to maximize recovery and production); the well trajectory planning process 263 may include designing a well trajectory to maximize potential recovery and production while minimizing drilling risks and costs; the well trajectory planning process 264 may include selecting proper well tubing, casing and completion (e.g., to meet expected production or injection targets in specified reservoir formations); and the prospect process 265 may include decision making, in an exploration context, to continue exploring, start producing or abandon prospects (e.g., based on an integrated assessment of technical and financial risks against expected benefits).

The system 200 can include and/or can be operatively coupled to a system such as the system 100 of FIG. 1. For example, the workspace framework 110 may provide for instantiation of, rendering of, interactions with, etc., the graphical user interface (GUI) 120 to perform one or more actions as to the system 200. In such an example, access may be provided to one or more frameworks (e.g., DRILLPLAN, DRILLOPS, PETREL, TECHLOG, PETROMOD, ECLIPSE, INTERSECT, KINETIX/VISAGE, PIPESIM, etc.). One or more frameworks may provide for geo data acquisition as in block 210, for structural modeling as in block 220, for volume modeling as in block 230, for running an application as in block 240, for numerical processing as in block 250, for operational decision making as in block 260, etc.

As an example, the system 200 may provide for monitoring data, which can include geo data per the geo data block 210. In various examples, geo data may be acquired during one or more operations. For example, consider acquiring geo data during drilling operations via downhole equipment and/or surface equipment. As an example, the operational decision block 260 can include capabilities for monitoring, analyzing, etc., such data for purposes of making one or more operational decisions, which may include controlling equipment, revising operations, revising a plan, etc. In such an example, data may be fed into the system 200 at one or more points where the quality of the data may be of particular interest. For example, data quality may be characterized by one or more metrics where data quality may provide indications as to trust, probabilities, etc., which may be germane to operational decision making and/or other decision making. As an example, the system 200 of FIG. 2 may include one or more ML models, for example, consider one or more ML models for use in one or more types of workflows.

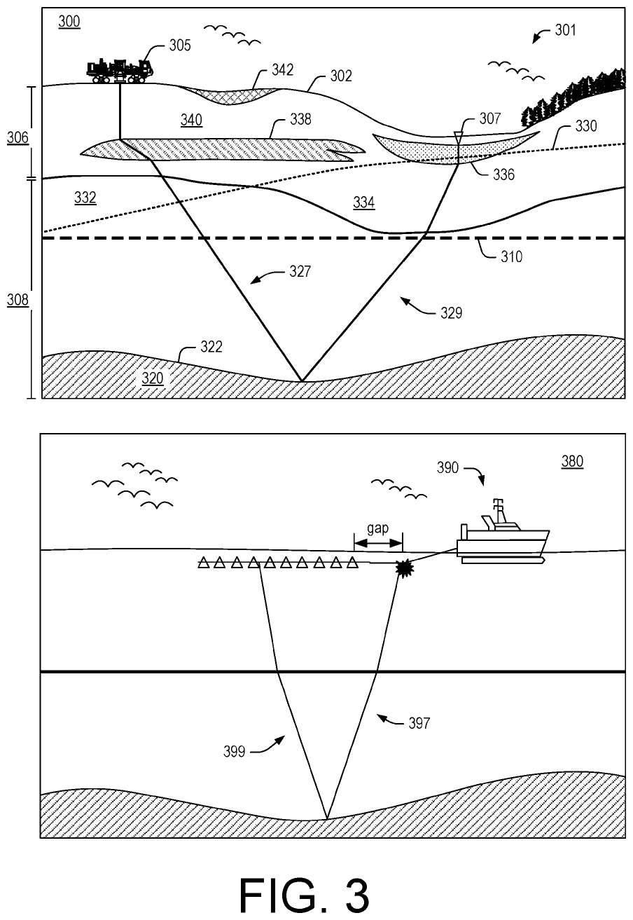

FIG. 3 shows an example of a land system 300 and an example of a marine system 380 that may be implemented to acquire seismic data. As mentioned, the system 200 of FIG. 2 may utilize seismic data for performing seismic interpretations (see, e.g., the seismic interpretation block 214), which may facilitate structural modeling, for example, to identify one or more features of a surface model (see, e.g., the surface models block 220). As explained, various models may be grid or mesh models suitable for performing one or more workflows such as, for example, a simulation workflow that simulates physical phenomena. Seismic data may be utilized in one or more workflows to evaluate a subsurface region, identify location(s) of hydrocarbons, determine one or more borehole trajectories, etc. As an example, seismic data may be utilized to identify one or more discontinuities, which may be a fault, a fracture, etc. In geophysics, a discontinuity may be defined as a subsurface boundary or interface at which a physical quantity, such as velocity of transmission of seismic waves, changes abruptly. For example, the velocity of P-waves increases dramatically (from about 6.5 to 8.0 km/s) at the Mohorovicic discontinuity between the Earth's crust and mantle. A fault, a fracture, etc., may also be a subsurface boundary or interface at which a physical quantity changes, which may provide for identification thereof via seismology.

In the example of FIG. 3, the land system 300 is shown in a geologic environment 301 that includes a surface 302, a source 305 at the surface 302, a near-surface zone 306, a receiver 307, a bedrock zone 308 and a datum 310 where the near-surface zone 306 (e.g., near-surface region) may be defined at least in part by the datum 310, which may be a depth or layer or surface at which data above are handled differently than data below. For example, a method can include processing seismic data that aims to “place” the source 305 and the receiver 307 on a datum plane defined by the datum 310 by adjusting (e.g., “correcting”) travel times for propagation through the near-surface region (e.g., a shallower subsurface region).

In the example system 300 of FIG. 3, the geologic environment 301 can include various features such as, for example, a layer 320 that defines an interface 322 that can be a reflector, a water table 330, a leached zone 332, a glacial scour 334, a buried river channel 336, a region of material 338 (e.g., ice, evaporates, volcanics, etc.), a high velocity zone 340, and a region of material 342 (e.g., Eolian or peat deposits, etc.).

In FIG. 3, the land system 300 is shown with respect to downgoing rays 327 (e.g., downgoing seismic energy) and upgoing rays 329 (e.g., upgoing seismic energy). As illustrated the rays 327 and 329 pass through various types of materials and/or reflect off of various types of materials.

Various types of seismic surveys can contend with surface unevenness and/or near-surface heterogeneity. For example, a shallow subsurface can include large and abrupt vertical and horizontal variations that may be, for example, caused by differences in lithology, compaction cementation, weather, etc. Such variations can generate delays or advances in arrival times of seismic waves passing through them relative to waves that do not. By accounting for such time differences, a seismic image may be of enhanced resolution with a reduction in false structural anomalies at depth, a reduction in mis-ties between intersecting lines, a reduction in artificial events created from noise, etc.

As an example, a method can include adjusting for such time differences by applying a static, or constant, time shift to a seismic trace where, for example, applying a static aims to place a source and receiver at a constant datum plane below a near-surface zone. As an example, an amount by which a trace is adjusted can depend on one or more factors (e.g., thickness, velocity of near-surface anomalies, etc.).

In FIG. 3, the datum 310 is shown, for example, as a plane, below which strata may be of particular interest in a seismic imaging workflow. In a three-dimensional model of a geologic environment, a near surface region may be defined, for example, at least in part with respect to a datum. As an example, a velocity model may be a multidimensional model that models at least a portion of a geologic environment. As an example, an earth model may be or include a velocity model (e.g., one or more parameters as to one or more physical characteristics that may have an effect on seismic velocity).

In the example of FIG. 3, the source 305 can be a seismic energy source such as a vibrator. As an example, a vibrator may be a mechanical source that delivers vibratory seismic energy to the Earth for acquisition of seismic data. As an example, a vibrator may be mounted on a vehicle (e.g., a truck, etc.). As an example, a seismic source or seismic energy source may be one or more types of devices that can generate seismic energy (e.g., an air gun, an explosive charge, a vibrator, etc.).

Vibratory seismic data can be seismic data whose energy source is a vibrator that may use a vibrating plate to generate waves of seismic energy. As an example, the frequency and the duration of emitted energy can be controllable, for example, frequency and/or duration may be varied according to one or more factors (e.g., terrain, type of seismic data desired, etc.).

As an example, a vibrator may emit a linear sweep of a duration that is of the order of seconds (e.g., at least seven seconds, etc.), for example, beginning with high frequencies and decreasing with time (downsweeping) or going from low to high frequency (upsweeping). As an example, frequency may be changed (e.g., varied) in a nonlinear manner (e.g., certain frequencies are emitted longer than others, etc.). In various vibrator scenarios, resulting source wavelet can be one that is not impulsive. As an example, parameters of a vibrator sweep can include start frequency, stop frequency, sweep rate and sweep length.

As an example, a vibrator may be employed in land acquisition surveys for areas where explosive sources may be contraindicated (e.g., via regulations, etc.). As an example, more than one vibrator can be used simultaneously (e.g., in an effort to improve data quality, etc.).

As an example, a receiver may be a may be a UNIQ sensor unit (SLB, Houston, Texas). As an example, a sensor unit can include a geophone, which may be configured to detect motion in a single direction. As an example, a geophone may be configured to detect motion in a vertical direction. As an example, three mutually orthogonal geophones may be used in combination to collect so-called 3C seismic data. As an example, a sensor unit that can acquire 3C seismic data may allow for determination of type of wave and its direction of propagation. As an example, a sensor assembly or sensor unit may include circuitry that can output samples at intervals of 1 ms, 2 ms, 4 ms, etc. As an example, an assembly or sensor unit can include an analog to digital converter (ADC) such as, for example, a 24-bit sigma-delta ADC (e.g., as part of a geophone or operatively coupled to one or more geophones). As an example, a sensor assembly or sensor unit can include synchronization circuitry such as, for example, GPS synchronization circuitry with an accuracy of about plus or minus 12.5 microseconds. As an example, an assembly or sensor unit can include circuitry for sensing of real-time and optionally continuous tilt, temperature, humidity, leakage, etc. As an example, an assembly or sensor unit can include calibration circuitry, which may be self-calibration circuitry.

In FIG. 3, the system 380 includes equipment 390, which can be a vessel that tows one or more sources and one or more streamers (e.g., with receivers). In the system 380, a source of the equipment 390 can emit energy at a location and a receiver of the equipment 390 can receive energy at a location. The emitted energy can be at least in part along a path of the downgoing energy 397 and the received energy can be at least in part along a path of the upgoing energy 399.

In various systems, for one or more reasons, a gap in coverage may exist. For example, in the system 380 a gap is identified and labeled where the gap may be defined as a distance between a seismic source and a seismic receiver. In such an example, the distance may be considered a practical or a safe distance for locating a seismic receiver from a seismic source. If a seismic receiver is too close to a seismic source, the seismic receiver may experience a rather large shock wave and/or may otherwise experience energy that may be quite high and raise concerns with calibration, dynamic range, etc.

In the examples of FIG. 3, the paths are illustrated as single reflection paths for sake of simplicity. In the environments illustrated, additional interactions, reflections can be expected. For example, ghosts may be present. A ghost can be defined as a short-path multiple, or a spurious reflection that occurs when seismic energy initially reverberates upward from a shallow subsurface and then is reflected downward, such as at the base of weathering or between sources and receivers and the sea surface. As an example, the equipment 390 can include a streamer that is configured to position receivers a distance below an air-water interface such that ghosts can be generated where upgoing energy impacts the air-water interface and then reflects downward to the receivers. In such an example, a process may be applied that aims to “deghost” seismic data. Deghosting can be applied to marine seismic survey data where such a process aims to attenuate signals that are downgoing from an air-water interface (e.g., a sea surface interface). As mentioned, one or more other techniques, technologies, etc., may be utilized for seismic surveying (e.g., ocean bottom cables, ocean bottom nodes, etc.).

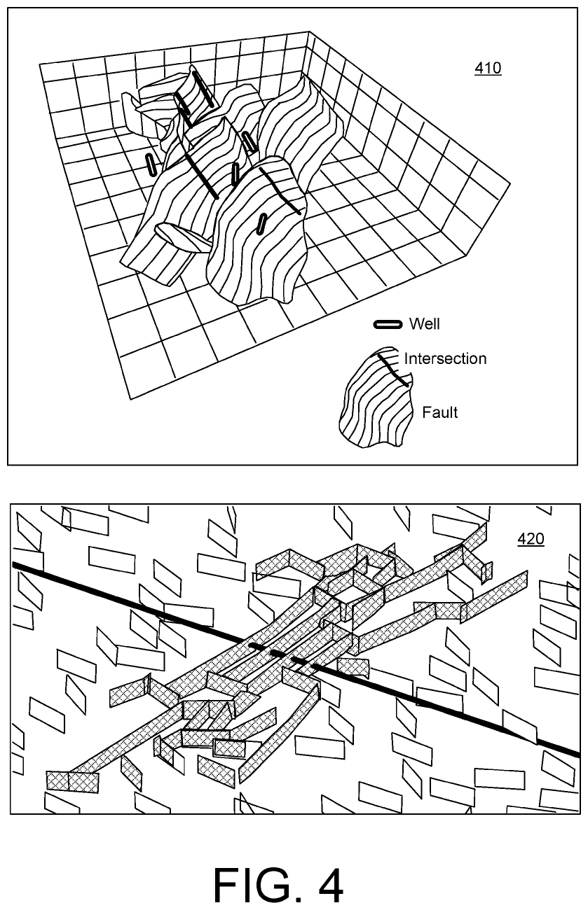

FIG. 4 shows examples of geologic environments 410 and 420 that include structures such as faults, fractures, etc., which may be represented by fault surfaces, fracture surfaces, etc. In the example environment 410, a fault may intersect one or more other faults and one or more wells may be present in the environment 410, which may interest a fault or faults. As shown, the environment 410 includes a fault network. In the example environment 420, fractures may be present and, for example, represented as a discrete fracture network (DFN). As an example, fractures can include natural and/or artificial fractures. As shown in FIG. 4, fractures may form a fracture network that is interconnected such that fluid may flow in the fracture network from one fracture to another fracture and, for example, to one or more wells.

As explained with respect to FIG. 4, fractures may form a fracture network that is interconnected such that fluid may flow in the fracture network from one fracture to another fracture and, for example, to one or more wells. Such types of interconnections may be beneficial or may be detrimental. For example, it can be detrimental for a fracture generated by hydraulic fracturing using one well to extend to an extent that it intersects another well. In such an example, fluid drainage for the region fractured may be suboptimal. To address such detrimental types of interconnections, during hydraulic fracturing, one or more types of data may be acquired and utilized to determine if a fracture is propagating in a direction and to an extent that it may intersect another well and/or a fracture or fractures that are in fluid communication with another well or wells.

As explained, seismic data may provide for identification of various types of subsurface structural features. As shown in the environment 310, one or more wells may be positioned with respect to one or more faults, which may include one or more fault intersections (e.g., two faults that intersect). As shown in the environment 320, a well may be drilled and completed for purposes of generating fractures, which may aim to increase production of hydrocarbons from a reservoir. In various instances, fracturing operations may account for presence of one or more faults. For example, consider a scenario where a fracture is to be generated to an extent that it does not intersect a fault, as a fault, depending on characteristics thereof, may provide for undesirable transmission of fluid. As explained, seismic data may be utilized in one or more workflows that may aim to produce fluid from a subsurface reservoir.

As an example, interpretations, whether by humans and/or machines (e.g., via one or more machine learning-based processes, etc.), may utilize 2D seismic data, 3D seismic data, data derived from seismic data, wellbore data, etc. As an example, interpretation may aim to store points, lines, curves, etc., which may represent feature boundary surfaces, associated properties, fault surfaces, fault polygons, etc. As an example, interpretations may provide for data represented as regularly sampled grids, polyline sets, points sets, polygons, a 2D interpretation representation, etc.; noting that type of representation may depend upon type of interpretation. As an example, a grid may be used to store 3D horizon interpretations and associated properties. As an example, polyline sets may be used to store faults that may be interpreted as sticks or segments. As an example, polygons may be used to store intersections between a fault and a horizon, horizon-horizon intersections, surface boundaries, tiploops, etc. As explained, seismic data-based interpretations of discontinuities may be generated using one or more techniques where such interpretations may be stored, for example, as points defined in a multidimensional space.

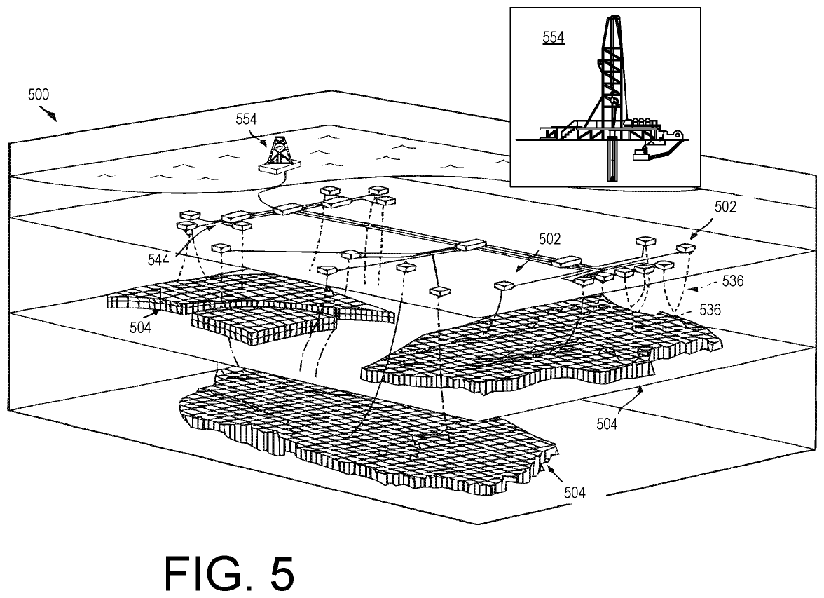

FIG. 5 shows an example of a geologic environment 500 as including various types of equipment and features. As shown, the geologic environment 500 includes a plurality of wellsites 502, which may be operatively connected to a processing facility. In the example of FIG. 5, individual wellsites 502 can include equipment that can form individual wellbores 536. Such wellbores can extend through subterranean formations including one or more reservoirs 504. Such reservoirs 504 can include fluids, such as hydrocarbons. As an example, wellsites can draw fluid from one or more reservoirs and pass them to one or more processing facilities via one or more surface networks 544. As an example, a surface network can include tubing and control mechanisms for controlling flow of fluids from a wellsite to a processing facility. In the example of FIG. 5, a rig 554 is shown, which may be an offshore rig or an onshore rig. As an example, a rig can be utilized to drill a borehole that can be completed to be a wellbore where the wellbore can be in fluid communication with a reservoir such that fluid may be produced from the reservoir.

As explained, wellbores (e.g., boreholes) may be planned and drilled with respect to one or more structural features of a subsurface environment, which may include one or more types of discontinuities. As an example, a framework may provide for discontinuity modeling using seismic data and/or information derived therefrom. In such an example, modeling may involve generating one or more types of grid or mesh models of a subsurface region, which may be defined according to one or more resolutions. As to seismic data, resolution thereof may depend on how the seismic data are acquired. For example, a survey geometry or acquisition geometry may determine, at least in part, resolution of seismic data. In various instances, a resolution of seismic data may not be as fine as a desired resolution of a model. In such instances, uncertainties may exist in interpretations as to subsurface structural features. For example, consider seismic data that can be interpreted by machine and/or human to generate two faults when, in reality, one fault exists. To improve modeling, a framework may implement one or more techniques to improve representations of subsurface structural features. For example, such a framework may provide for determining whether or not structural indicia correspond to one or more than one structural feature.

As explained, subsurface environments may include discontinuities such as, for example, faults, fractures, etc. As to faults, fault modeling and editing tend to be tasks performed in structural modeling workflows. Fault geometries and relationships (e.g., connections between faults) may be used, for example, for reservoir properties characterization, drilling, reservoir simulation, etc.

Fault models tend to be based on fault interpretations, which may be provided as point sets and/or lines that have been interpreted from seismic data (e.g., volumetric seismic data or a seismic cube) as representing a fault or faults as a discontinuity or discontinuities. Fault modeling may utilize points of a given interpreted fault to generate a fault surface that represents the geometry of the fault as an object and then uses both information of a point set (e.g., interpretation results) and a surface (e.g., a surface model) to make guesses as to fault relationships. For example, consider faults that may be deemed truncating with a T-shaped relationship or faults that may be deemed crossing with an X-shaped relationship. Such relationships may then be used to produce a final geometry of a fault model, for example, by introducing one or more intersections and/or truncations within fault meshes to reproduce such subsurface structural features with high fidelity as including appropriate connections.

The advent of machine learning (ML) to extract fault interpretations has led to a situation where a user may be faced with a much larger amount of interpreted fault information, which may be at times, arguably, of lesser quality and/or consistency than hand-picked interpretations from one or more experienced human interpreters. Therefore, building a model from ML-based interpretations can be more demanding and challenging within a workflow. In various instances, ML-based interpretations may ease one portion of a workflow while burdening another. As to model building, where a model is to be edited due to an error in representations of one or more discontinuities, the time and resource demands for editing may be substantial. For example, a model may demand re-gridding, grid refinement, etc., which may also demand performing quality assurance checks on a resulting edited model. Hence, an ability to arrive at an accurate representation of discontinuities early in a workflow can reduce burdens (e.g., rework, etc.) as to a later part of a workflow or as to other workflows that may depend on a modeling result. As an example, a framework may provide for discontinuity modeling in a manner that reduces demand for humans and/or that facilitates one or more tasks, which may include field operation tasks. As an example, a framework may provide for rendering of one or more graphical user interfaces (GUIs) that ease visualization and/or interactions for one or more humans. Such an approach may reduce demands for human intervention, leverage ML-based interpretations, and expedite building of accurate models suitable for one or more tasks (e.g., simulation, field operations, control, etc.).

As explained, various aspects of modeling of faults may be performed automatically, however, some aspects of a modeling workflow demand substantial attention from one or more humans after an initial model (e.g., an automated draft model, etc.) may be generated. For example, consider tasks such as merge, snap and repair. In such an example, the tasks or actions may be referred to as joining actions as they may be utilized to join interpretations, for example, to provide a unitary discontinuity, to provide a relationship between two discontinuities (e.g., or more than two discontinuities), etc.

As to merge, for instance, some distinct interpretations may be merged in a single fault, as an ML-based approach may fail to identify that two or more distinct interpretations belong to a single fault. In such an example, two distinct interpretations may be two sets of points that may be reprocessed responsive to a merge determination to become a single set of points to define a single fault (e.g., discontinuity) where, for example, the single fault is to be recreated from the larger set of points (e.g., the combination of the two sets of points). As to snap, some interpretations may benefit from being completed with some additional points to make a model more accurate. As an example, a snap may imply snaping an interpretation of a minor fault to a major (e.g., truncating) fault, which may help to assure that these two faults are in a relationship, rather than geometrically disconnected. Snap tasks tend to be extremely time consuming from a user's perspective as a snap task implies adding points in 3D to complete one or more faults to force one or more specific relationships. As to repair, fault relationships may be guessed automatically from an interpretation but some interpretation data (e.g., points in 3D space generally) may be missing and thereby lead to erroneous geometries for a fault-fault contact. As explained, merging can result in a single fault while snapping and repairing can involve more than one fault as they pertain to fault relationships.

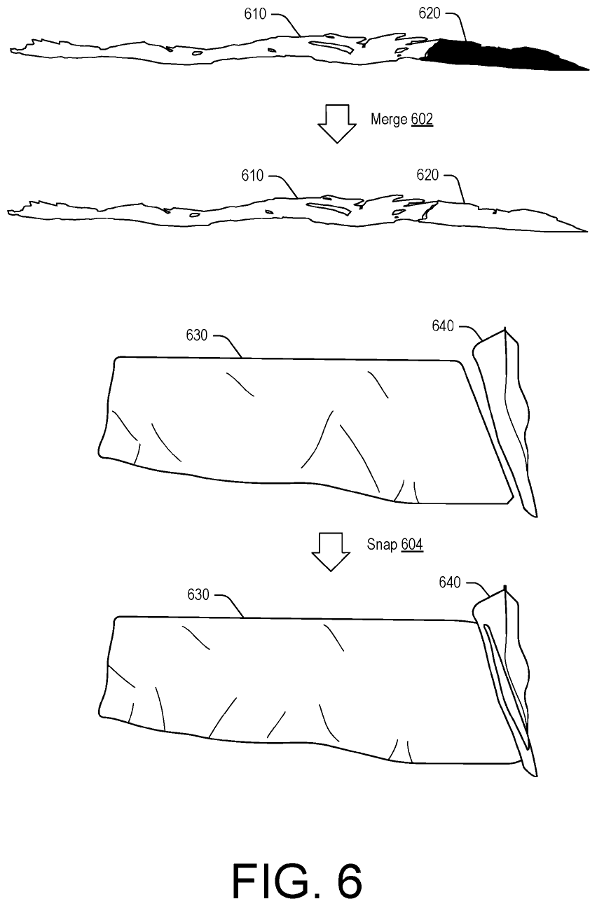

FIG. 6 shows two examples of fault relationships techniques, specifically a merge action 602 and a snap action 604 where, respectively, merging and/or snapping is appropriate to more accurately represent actual subsurface structures. In the first example, two distinct interpretations 610 and 620 may be determined to be, in actuality, a single fault. Hence, a framework may provide for identification of the two distinct interpretations as an issue and performance of an action to remedy the issue. As shown, the action may be the merge action 602. In such an example, the framework may provide one or more probabilistic metrics and/or physical metrics to determine whether a recommendation as to an action and/or automatic performance of an action are to occur. For example, a framework may operate automatically according to one or more criteria and/or in a manner whereby a human may view a GUI to approve an action, deny an action, modify an action, etc. In the first example, the merge action 602 may be indicated and performed to merge the interpretations 610 and 620 such that they represent a single fault. As to some reasons why interpretations may give rise to demand for a merge action, consider seismic data that may include one or more regions of low signal to noise (e.g., low SNR), missing data (e.g., due to receiver issues, etc.), illumination issues (e.g., lacking seismic energy, etc.), multiples issues (e.g., presence of multiples), resolution issues, etc. Hence, one set of points may appear to be separate from another set of points, particularly where a machine learning approach is implemented to associate points with subsurface structures. As an example, a framework may implement a merge action to thereby improve machine learning generated interpretation results. As an example, a merge action may include regenerating a representation of a fault (e.g., a discontinuity) responsive to merging of interpretations, which may be evaluated on at least a pair-by-pair basis.

As to the second example in FIG. 6, involving two distinct interpretations 630 and 640, a framework may provide for indicating and/or performing the snap action 604. In such an example, the two distinct interpretations may be deemed to be two distinct faults with a relationship between them such that the snap action 604 may be performed to snap the faults together such that appropriate contact is made (e.g., a contact between two faults that did not exist previously). In such an example, a gap may exist whereby a snap action aims to eliminate the gap as being likely an erroneous gap. In such an example, one fault may be held static while another fault is snapped a distance to contact the static fault. In such an example, a determination may be made as to which fault is extended to provide surface-to-surface contact. For example, a metric or metrics may be computed for extension of each fault individually and for extension of both faults where the metric or metrics may indicate which type of movement is most appropriate (e.g., lowest cost, most accurate, etc.). As an example, an extension may provide for extending a perimeter of one fault with respect to another fault such that contact is created that substantially represents how the two faults exist in nature.

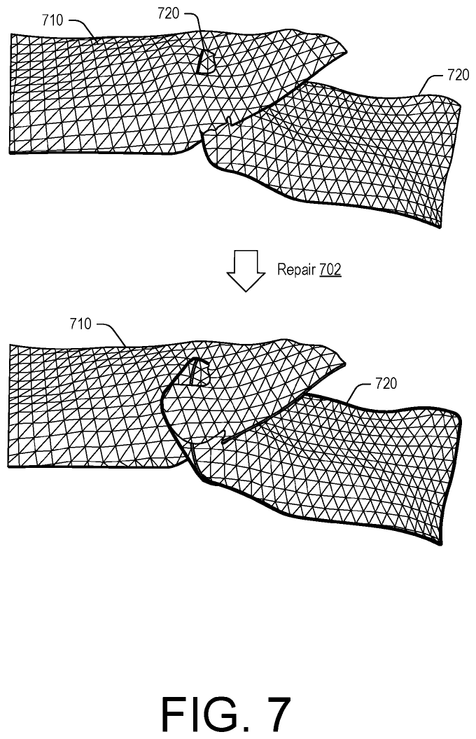

FIG. 7 shows an example of faults 710 and 720 where a repair action 702 is implemented. In the example of FIG. 7, the faults 710 and 720 are already contacting one another, however, the fault 720 has a discontinuous and incomplete contact line. In the repair action 702, virtual points may be added that can extend the fault 720 with respect to the fault 710 such that a better contact line is formed. In such an example, the relationship between the faults 710 and 720 may be better represented in a 3D model of a subsurface region. For example, consider an improved relationship that more accurately represents the actual relationship of the faults 710 and 720, which may be relevant to simulation of geomechanics, fluid flow, etc. In such an example, one fault may be held static while another fault is repaired through addition of points. In such an example, a determination may be made as to which fault or faults to add points thereto. For example, a metric or metrics may be computed for point addition as to each fault individually and for point addition of both faults where the metric or metrics may indicate which type of point addition is most appropriate (e.g., lowest cost, most accurate, etc.). As shown in the example of FIG. 7, points added can be on an opposite side of a fault, for example, points can be added to the fault 720 that are to one side of the fault 710. In such an example, the fault 710 may have an approaching side with respect to the fault 720 (e.g., lower right) and an opposite side (e.g., upper left) whereby the added points can be added to the fault 720 to repair the fault 720 by adding an additional portion to the fault 720 that is on the opposite side of the fault 710.

While the examples of FIG. 6 and FIG. 7 pertain to faults as discontinuities, fractures, whether artificial and/or natural may be considered. For example, consider merging of two fractures to define one fracture, snapping of two fractures to more accurately represent a relationship between the two fractures, and/or repairing of two fractures to more accurately represent a relationship between the two fractures. In such examples of snapping and repairing, one fracture may be generated through hydraulic fracturing while another fracture may be a natural fracture. As an example, a framework may provide for improving a discrete fracture network (DFN). In various instances, hydraulic fractures may be discerned through seismology, which may include microseismic sensing during hydraulic fracturing. Such an approach may generate points in space where a framework may provide for determining how sets of points may be related (e.g., merged, snapped, repaired, etc.).

As explained, actions may include one or more of merge, snap and repair; noting that one or more additional or alternative actions may be implemented by a framework, as appropriate. As an example, a workflow may provide for using a hierarchy of actions where, for example, one action may be performed before another action. In various instances, a merge action may be applied prior to a snap action, which may be applied prior to a repair action. For example, a workflow may involve assessing interpretations as to benefits of merging and, once one or more merges have been performed, the workflow may involve assessing the interpretations (e.g., as revised per the one or more merges and/or as originally provided) as to benefits of snapping. In various instances, relationships whether existing and/or generated through snapping may benefit from repair. Hence, a workflow may involve assessing interpretations and/or revised interpretations as to repair, which may be performed after assessments as to one or more other actions (e.g., merge, snap, etc.).

As explained, a framework may provide for expediting one or more workflows in a manner that may improve modelling and tasks that depend on a model or models. As explained, such a framework may be operatively coupled to one or more ML-based frameworks that may identify prospective structural features in space. In such an approach, the volume of features (e.g., number, etc.) may be processed expeditiously by the framework to hone in on one or more regions with possible issues, which may be accompanied by recommendations for action and/or automatic actions to address such possible issues. As an example, a framework may provide for ranking issues such that higher ranked issues may be addressed automatically and/or via human interaction. As an example, a framework may operate using one or more criteria where issues are handled automatically, semi-automatically and/or manually. For example, consider issues with low uncertainty being addressed automatically while issues within a range of uncertainty may be flagged for semi-automatic intervention. In such an example, where uncertainty of two discontinuities being merged is high, that may be an indication that the two discontinuities are distinct (e.g., separate). As an example, such an indication may be utilized to assess whether or not one or more actions may be recommended and/or performed (e.g., consider snapping and/or repairing).

As an example, a workflow may include implementing a framework that can facilitate human review of ML-based interpretation results as to discontinuities. Such an approach may address what may otherwise be an overwhelming task for a user and facilitate generation of fault models of an acceptable level of quality in a reasonable amount of time due (e.g., due to identification of issues, guidance as to actions, visualizations, etc.).

As an example, a framework may provide information that may be utilized as feedback to an ML-based interpretation process. For example, a human may review merge, snap and/or repair recommendations, actions, etc., in a manner that may generate information as to relationships between possible interpretations of seismic data and/or data derived from seismic data.

As explained, a framework may provide for implementation of various actions, which may include merging, snapping and/or repairing, where merging may precede snapping and/or repairing. As an example, a framework may provide for implicit fault modeling where a fault may be modeled implicitly within a model. Some example techniques described herein include one or more of the three parts. As explained, a framework may provide for selection of candidates for editing such that a workflow may be at least in part automated. For example, consider a framework that provides for automatically detecting possible issues in a fault model, which may be addressed by one or more actions (e.g., merge, snap, repair, etc.). In various instances, a framework may operate to detect types of issues independently, which may be interspersed with actions. For example, consider sequentially detecting and/or performing actions. In various instances, a sequence may involve merging of discontinuity interpretations followed by snapping and/or repairing to generate more accurate implicit discontinuity models for inclusion within a model of a subsurface region.

As explained, various techniques may be applied to generate interpretations, which may include automated techniques such as, for example, machine learning-based techniques. As an example, a framework may provide for ranking of possible edits to interpretations. For example, consider ranking of candidates for editing (e.g., merge, snap, repair, etc.) in a manner that automatically ranks the candidates from most likely to less likely, which may be, for example, in a before compared to an after sense, etc. As an example, a framework may find some candidates that are either not correct or that might modify an original interpretation too much. As an example, a framework may provide for human intervention where, for example, a human-in-the-loop (HITL) may be presented with a GUI that can render appropriate information and/or visualizations to aid in decision-making and/or implementing one or more actions (e.g., and/or undoing one or more actions, whether performed automatically and/or by a human). As an example, a ranking-based approach may allow a user to perform operations until a user is satisfied as to an amount of model improvement. In such an example, a user may proceed according to ranked candidates and address a number of top ranked candidates while discarding lower ranked (e.g., remaining candidates), which may be less likely to be included in a model, to improve a model, etc. As an example, one or more metrics may be utilized for ranking where one or more thresholds may be utilized to establish a cutoff for performing one or more actions. In such an example, consider a cost metric where a lesser cost may indicate that an action may not be detrimental. In such an example, possible actions as to lower candidates ranked with costs above a threshold may be discarded. As an example, a numeric approach may be implemented, for example, where a user may address a reasonable number of ranked candidates (e.g., consider a number from 10 to 100, etc.).

As an example, a method may be implemented for discontinuity modeling, whether discontinuities are modeled implicitly and/or explicitly. For example, merge candidates proposed and ranked, snap candidates proposed and ranked, and/or repair candidates proposed and ranked may be utilized for an explicit modeling approach and/or an implicit modeling approach.

As an example, as to snapping and repairing, these actions may include one or more common techniques (e.g., as to assessment, action, etc.); however, additional tests may be performed as to repair in comparison with snap (see, e.g., the action 604 of FIG. 6 and the action 702 of FIG. 7).

As explained, a framework may provide for expediting one or more workflows, for example, to build discontinuity models faster. As explained, presentation of a ranked list and evaluation thereof (e.g., as to visualizations, individual metrics, etc.) may help to improve confidence in performance of an action or actions to generate a more accurate model. As an example, an automated approach to identification of possible actions for candidates may be relatively thorough and, for example, controlled via one or more adjustable parameters. Such an approach may provide confidence in that opportunities to improve a model or models using one or more actions are not missed (e.g., according to level of detail specified via one or more parameters, etc.).

As explained, a framework may provide for improving implicit discontinuity modeling such as, for example, modeling of faults, fractures, etc.

According to various examples, an implicit model methodology may be used to generate a description of an individual discontinuity in the form of a height map. For example, consider generation of an individual fault in the form of a height map, which may be computationally less expensive than various other techniques and may be accurate enough to serve as a basis for fault modeling.

As an example, in an implicit representation approach, a function may be defined everywhere within a three-dimensional (3D) space, which may provide for enabling broad 3D queries about, for example, surface intersections and/or distances that may provide for simplifying implementation of one or more aspects of one or more workflows. An implicit representation approach may enable, for a given fault, to query any point in space to know one or more of: (a) its signed distance to the fault; (b) its projection on the fault; and (c) the signed distance of its projection to a tiploop of the fault (e.g., a border of the fault, etc.). As an example, a tiploop may be defined using fault tips where, for example, a loop is defined using the fault tips. As an example, a tiploop attribute may be defined as a distance, which may be a distance as to a point in space from a tiploop where, for example, a point in space may be inside a tiploop, on a tiploop, or outside a tiploop.

As explained, a framework may provide for utilizing a heightmap-based approach. For example, consider using a height map surface which, in a basic form, may be a discretization of a height map on a two-dimensional (2D) grid aligned with a mean plane of a discontinuity such as, for example, a fault, a fracture, etc. In such an example, the 2D grid may be sized to extend beyond a discontinuity. For example, consider a 2D grid that may be a certain percent larger in one or more directions than a discontinuity. In such an example, the 2D grid may be ready for handling actions such as snap and/or repair actions. As an example, size of a 2D grid may be controllable via one or more parameters, which may be, for example, set by default, set according to one or more aspects of seismic data (e.g., resolution, etc.), and/or set by a user. As an example, consider a 2D grid that may be in a range from 0.1 percent to 20 percent larger than a projected discontinuity as may be represented by a set of interpretation points (e.g., points projected onto a plane). In such an example, a 2D grid approach may provide for expeditious rendering of visualizations, for example, in real-time, responsive to performance of an action (e.g., snapping, repairing, etc.). For example, a height map may be defined with respect to a 2D grid such that where a snap action or a repair action occur, the height map may already exist for the corresponding snap space or repair space. In such an example, a method may proceed without recomputing a height map for the snap space or repair space; noting that a tiploop may be adjusted, for example, along with a tiploop attribute that accounts for the adjusted tiploop. As to a merge action, where two sets of interpretations (e.g., two sets of points) are merged, a method may include generating a new height map using the two sets of interpretations as a combined, single set for a discontinuity. As explained, a hierarchy as to actions may exist where, for example, merge actions may be performed prior to actions such as snap and/or repair (e.g., actions that may not demand height map regeneration).

As an example, to compute a height map from interpretation data points, a framework may perform a method that implements various techniques, which may be within one or more spatial coordinate systems. For example, consider utilization of a coordinate system with u and v coordinates. In such an example, an additional coordinate may be denoted w such that a 3D space may be specified using u, v, and w coordinates.

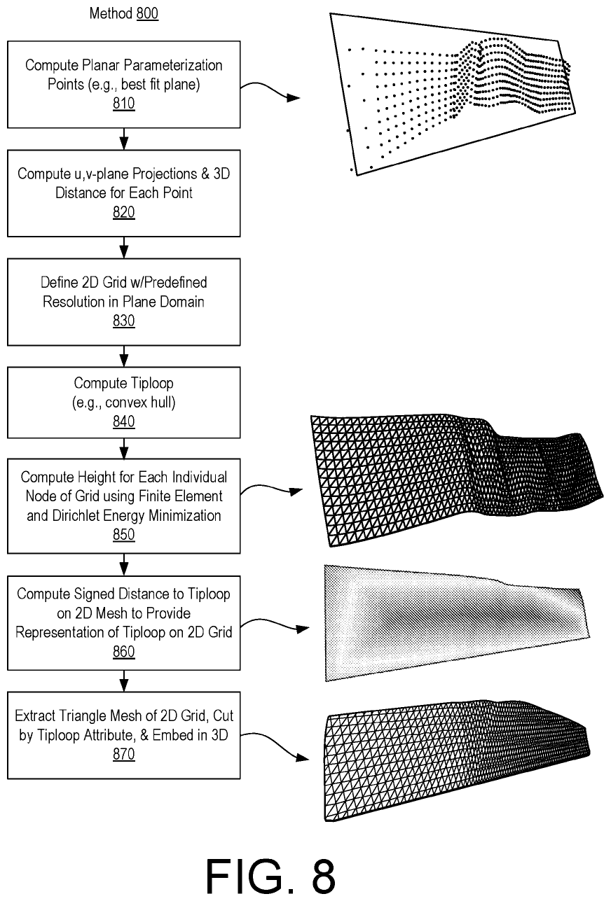

FIG. 8 shows an example of a method 800 along with various visualizations of a discontinuity and how it may be represented. As shown, the method 800 can include a compute block 810 for computing planar parameterization points (e.g., a best fit plane); a compute block 820 for computing u, v-plane projections and 3D distances for each point; a definition block 830 for define a 2D grid with a predefined resolution (e.g., 100 m, etc.) in a plane domain; a computation block 840 for computing a tiploop (e.g., a convex hull of points in 2D, etc.); a computation block 850 for computing a height for each individual node of the grid, for example, using finite elements and Dirichlet energy minimization; a computation block 860 for computing signed distance to tiploop attribute values on a 2D mesh (e.g., on each point), which can provide the representation of a tiploop on the 2D grid; and an extraction block 870 for extracting a triangle mesh of the 2D grid, as may be cut by a tiploop attribute and embedded in a 3D space.

In the example of FIG. 8, in association with the computation block 810, a visualization is shown of points (e.g., interpretation points) and a plane; in association with the computation block 850, a visualization is shown of a height map (e.g., quads exportable as triangles); in association with the computation block 860, a visualization is shown of contours of tiploop distances where a white contour indicates a tiploop where tiploop attributes (e.g., distance attributes) are provided for a portion of the plane outside of the tiploop, on the tiploop, and for the portion of the plane inside of the tiploop; and in association with the extraction block 870, a visualization is shown of a triangle mesh of a 2D grid as cut by the tiploop attributes where the triangle mesh may be embedded within a 3D space (e.g., a 3D model, etc.). As shown in the example of FIG. 8, points such as interpretation points associated with a perceived discontinuity (e.g., per an interpreter, a machine, etc.) may be transformed into a mesh (e.g., a 2D grid) with information representing a discontinuity.

As shown in the example of FIG. 8, a grid may be generated with a height map where the grid is larger than an actual discontinuity (e.g., a fault). As explained, such an approach can provide for expediting computations with respect to actions such as, for example, a snap action and/or a repair action, which may act to improve representations of relationships between discontinuities. As an example, by providing a geometric representation that is larger than a discontinuity perimeter, various assessments as to actions may be performed and/or actions performed more expeditiously to improve relationships between discontinuities. As explained, a framework may provide for rendering of one or more GUIs where visualizations may be presented such that a user may see how two discontinuities appear in space and how an action may improve a relationship therebetween. As an example, a framework may provide for real-time or near real-time updates to visualizations responsive to performing an action (e.g., consider less than 1 second, less than 0.5 second, etc.).

As to height map construction, a 2D grid may be represented with triangles, which may be quads in a finite element implementation, which may, for example, be explicitly presented as triangles during extraction of a mesh phase of a method.

As an example, various height map techniques may provide for efficiency. For example, consider efficiency in embedding of a tiploop as an implicit attribute that enables an ability to crop a height map mesh to generate a discontinuity model (e.g., a fault model, a fracture model, etc.). As explained, a geometric representation of a discontinuity in space may include information as to positions of portions of the discontinuity derived from interpretation points, which may be present as a height map values (e.g., deviations from a plane, etc.) and tiploop attribute values (e.g., distances from a tiploop derived from tips of a discontinuity, etc.).

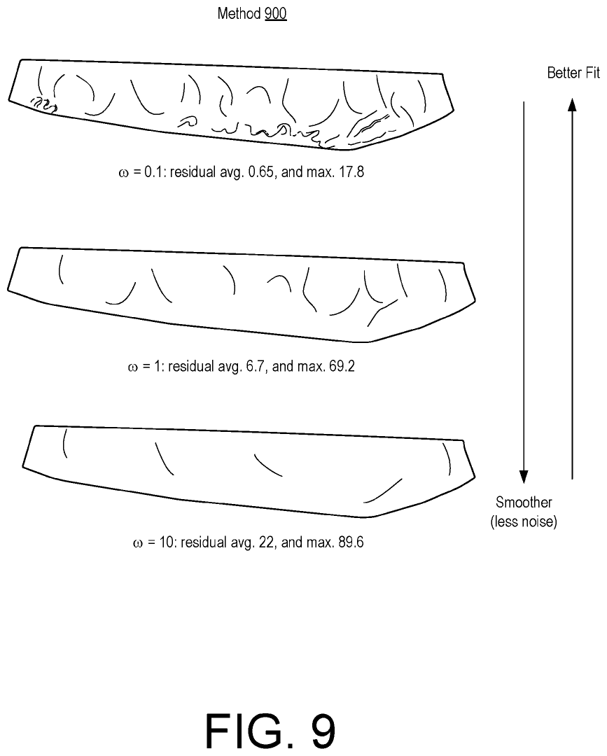

FIG. 9 shows an example of a method 900 that may be implemented with respect to a discontinuity. For example, tradeoffs may be made between a smoother representation with less noise and a more accurately fit representation (e.g., as to interpretation points). In the example of FIG. 9, a parameter ω may be adjustable, for example, to provide for a balance between smoothness and fit. As shown, a height map technique may operate according to a parameter to control smoothness and quality of fit of each discontinuity. In the example of FIG. 9, the parameter ω may represent a tradeoff between curvature and actual positions of interpretation points. As an example, a value of the parameter ω selected by a user may be utilized as feedback to a machine learning-based interpretation process. As an example, such a value may be associated with noise and/or one or more other characteristics of seismic data and/or data derived from seismic data. For example, where a user selects a larger value for the parameter ω that larger value may indicate a higher level of noise (e.g., lower SNR) in data relied upon for performing an interpretation process.

As explained, using height maps can enable an ability to build a fault model in a fraction of the time compared to approaches that explicitly model faults. As an example, a framework may utilize a regular 2D grid geometry that tends to be quite efficient where fitting to a 3D shape may be performed through a height attribute, which may be specified as a single value for each node of a 2D grid.

As explained, a framework may provide for recommendation of and/or implementation of one or more actions. For example, once a model has been built, determinations as to which fault interpretations may be better to be merged, thereby offering improvements to consistency of the model, may be performed. In various instances, for a given pair of faults, respective height map residuals may be determined. As an example, a residual may quantify how well a fault model captures interpretation data, for example, by computing an average distance of the interpretation points to a surface. In such an example, where appropriate, two point sets may be merged and the residual of this merged fault determined using one or more techniques.

As an example, a framework may rank each potential merge by a ratio of the residual of the merge divided by the sum of the individual residuals of the two faults taken separately. In such an example, the lesser this ratio is, the more optimal is the new merged fault compared to the two faults as being two individual entities. At some value of this ratio, merging the faults may no longer make sense, which may operate as a trigger to stop merging operations and/or to stop recommending merging operations.

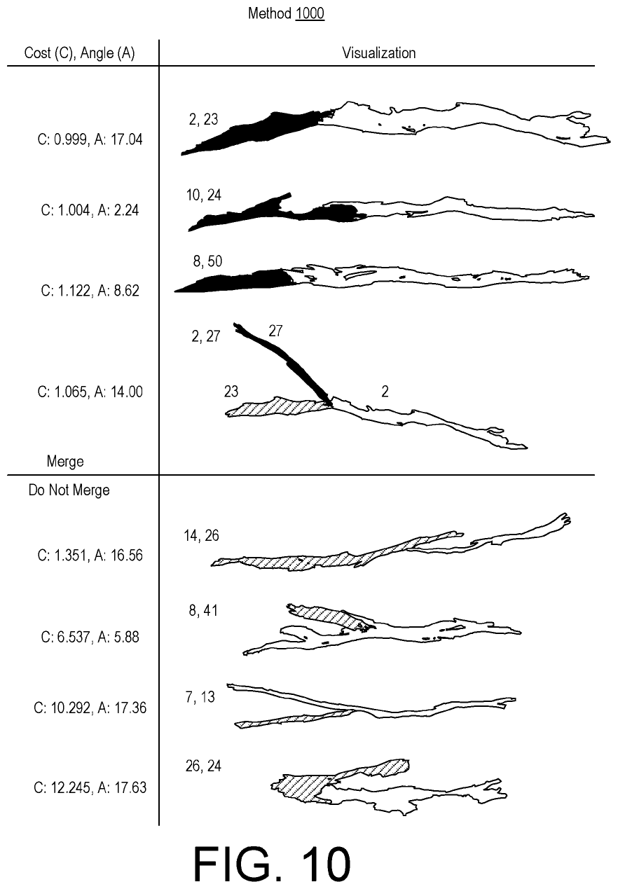

FIG. 10 shows an example of a method 1000 that includes identifying possible merge actions for candidates where, for example, a cutoff may be established using one or more metrics to discern candidates worth merging and candidates not worth merging. In the example of FIG. 10, points are labeled using numbers such as 2, 7, 8, 10, etc. In such an example, pairs may be considered such as, for example, 2 and 23, 10 and 24, etc. In such an example, a cost metric and an angle metric may be computed for each pair, each of which may have a corresponding threshold and/or for which a combined threshold may be provided. As shown, pairs with costs less than 1.351 are in the merge group, which may have angles less than a certain value (e.g., less than 17.36, etc.).

In the example of FIG. 10, the cost metric may represent the ratio of the residual for the merge and the residual faults, leading to a natural ordering of the merge candidates within a model with a number of faults (e.g., 10, 20, 100, etc.). At some level, the cost of a merge increases from 1.35 for a pair to 6.52 for the next pair, which may indicate that merging of various flagged pairs does not make sense. Yet, the pair 14, 26 may be flagged as not making sense because those two faults arguably form a T-shape and therefore should not be merged. Hence, one or more techniques may be applied for assessing merge candidates. As to the example cost metric, as to a threshold, consider values below approximately 1.5 as indicating possible likely benefits for performing a merge, which may be subject to one or more other criteria, constraints, etc. (e.g., consider T-shape, etc.).

As an example, a framework may provide for using a fault closeness criterion. For example, consider an approach that first filters fault pairs (e.g., interpretation point set pairs, etc.) based on proximity, which may be an initial criterion as to fault closeness, which may help determine if the framework is to run a tentative merge or not assessment. For example, consider an approach that combines fault distance and fault tiploop attributes of two faults to determine if a framework is to proceed with a merge assessment or not. In such an example, various fault pairs may be immediately labeled as not to merge, for example, without performing one or more further assessments. Such an approach may expedite decision-making and sorting through a large number of possible fault pairs.

As to candidates for snapping, a framework may determine if a fault A could be snapped onto another fault B, for example, using one or more techniques. As an example, a framework may include computing a virtual truncation line. For example, based on an implicit representation, a virtual contact line between two faults may be determined. Such a determination may be performed, for example, by extracting on each node of a height map mesh of the fault B, the height map distance of the fault A. In such an example, a framework may extract on the fault B the iso-surface zero representing the line on the fault B potentially in contact with the 3D extension of the fault A (e.g., noting that a height map may be defined in space beyond a tiploop of a fault). As an example, each node of a truncation line may be associated with a measure of length, which may be a sum of half of edge lengths that are attached to a node. In such an example, each node may carry a length (e.g., a length attribute), which may be utilized for one or more purposes (e.g., subsequent assessments, etc.).

As an example, a framework may provide for projecting a virtual truncation line on a tiploop. For example, in such an approach, the points of this virtual contact line may be projected on the tiploop of a fault A. In such an example, the parametric space of the fault A may be parametrized by two variables u and v where u is aligned with the longest axis of the fault plane and v is orthogonal and is aligned with the shortest axis of the fault plane. For example, points may be either projected along u (e.g., a u-zone if the point is within the fault A bounds for the v coordinates) and, vice-versa, along v (e.g., a v-zone if the point is within the fault A bounds for the u coordinates).

As an example, a framework may provide for selecting the best projection. For example, consider an approach that chooses a preference of going along the u projection or going along the v projection to snap a fault. As an example, there may be two possible sets of projections (e.g., along u or along v); noting that in various instances one may be empty, thereby simplifying the choice. As an example, in instances where both along u and along v provide for valid projections, the one that represents the longest part of a virtual contact line may be kept (e.g., each node of the virtual contact line being associated with a measure of length).

As an example, a framework may provide for generation of offset points. For example, gathered points on a truncation that have a u (or v) projection on a fault may be extended a relatively small distance off the fault (e.g., consider off a fault B) in order to make sure that they are on the other side of the fault (e.g., consider on the other side of the fault B) to make better contact (e.g., to assure contact is made along an entire snap line).

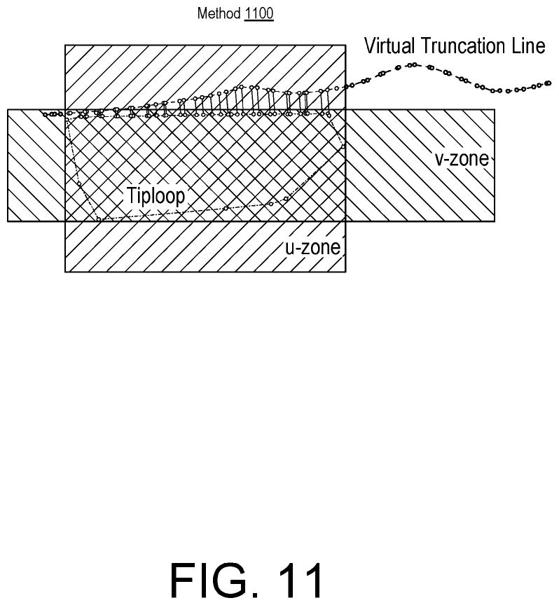

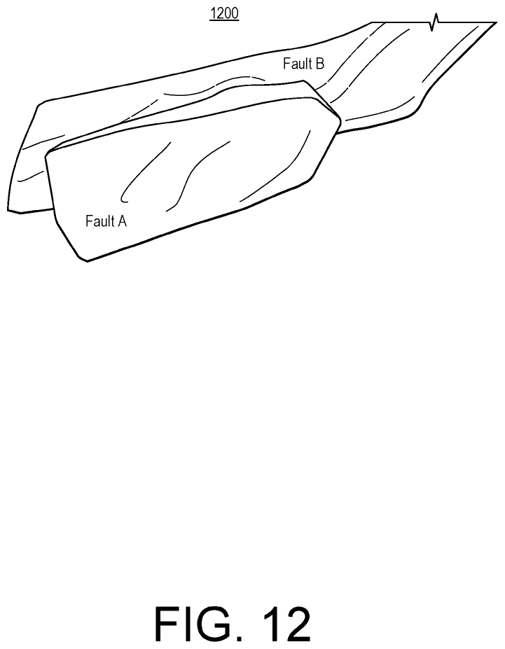

FIG. 11 shows an example of a method 1100 where a u-zone and a v-zone approach is implemented with respect to a tiploop of a fault to determine a virtual truncation line with respect to another fault. Specifically, FIG. 11 shows a 2D view of snapping (see, e.g., FIG. 12 for a 3D perspective view) according to an example via a visualization of the tiploop of a fault A, the virtual truncation line for the fault A on the fault B, and the u-zone and v-zone. In such an example, snapped points of the truncation line in the u-zone can be projected back to the tiploop of the fault A in the v coordinate direction.

FIG. 12 shows a perspective view of snapped faults 1200 resulting from snapping of the fault A and the fault B of the example of FIG. 11. In particular, FIG. 12 shows a result of the snap action explained with respect to the method 1100 of FIG. 11 (e.g., now in 3D).

As to snap candidates ranking, with each pair of faults determined, as an example, if a fault A may be snapped on a fault B, a ranking of the operations from the most likely to the less likely may be executed. As an example, a heuristic criterion may be that allows such ranking.

As an example, a length likelihood may be utilized. For example, for a fault pair a framework may determine a length of a virtual contact line projecting back to a fault A. As an example, a goal may be to have this length to be about the same of the fault u dimension or the fault v dimension; thus, for example, a ratio snap-contact-line/fault dimension close to unity may be used. As an example, a probability of one (unity) may be assigned in such an example and may be linearly decreasing if the ratio is less (or more) than one. In such an example, a length probability may be computed.

As an example, an area likelihood may be utilized. For example, consider an area of a snapped zone that may be compared with an initial area of a fault A. In such an example, the smallest area ratios may favor snapping where such a ratio may be maintained to be no larger than 1 (e.g., the area of the extension cannot be bigger than the original fault's surface). In such an example, an area probability may be computed.

As an example, a framework may provide for combining likelihoods. For example, consider two probabilities (e.g., length and area, etc.) that may be combined by multiplying them to make a single number for each pair. In such an example, the number may provide for ranking each potential snap by a global likelihood to be consistent with a modification already made on a model to thereby improve it.

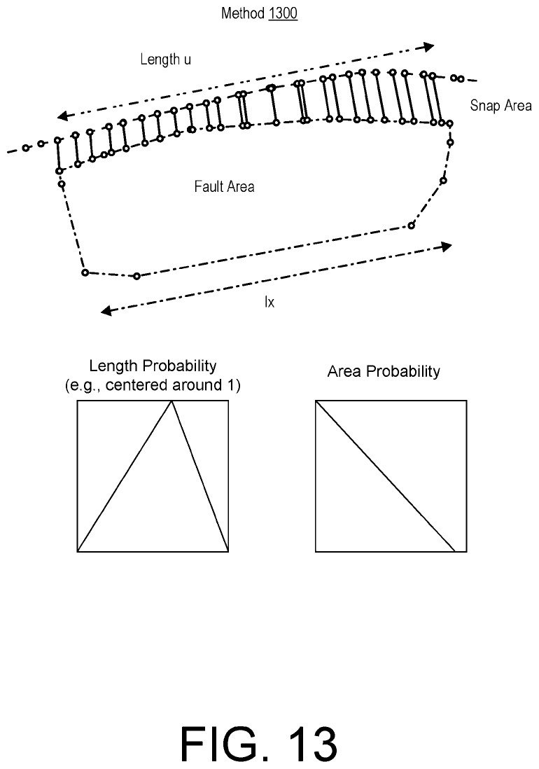

FIG. 13 shows an example of a method 1300 that may provide for computing snapping likelihood. In the example of FIG. 13, a visualization shows fault area of a fault, snap area, a length u and a length lx, along with example plots of length probability (e.g., centered around unity) and area probability. As an example, in the case of a u-projection, a normalized length may be computed by dividing a length of a snapped truncation line (e.g., length u) by the longest length of the fault (lx). In such an example, the normalized area may be computed by dividing the snap area by the fault area; noting that if it was a v-projection, then such a method may divide by the other length (ly) of the fault. As an example, a framework may utilize a defined likelihood to help defining a global likelihood of a given fault snap.

As an example, a method may include converting normalized quantities to probabilities, which may be visualized using one or more plots. As an example, one or more other metrics may be utilized by a framework as to making determinations with respect to snapping. For example, consider angle of attack, maximum distance (e.g., in u, v projections, etc.), selection of a maximum distance from projections in each of multiple coordinate directions, etc.

As explained, a framework may provide for ranking possible snapping candidates from the most likely to the least likely. As an example, one or more machine learning techniques may be implemented, for example, to determine a given number that above which snaps may be accepted and below which snaps may be discarded. As an example, a framework may include empirically determining a given number that above which snaps may be accepted and below which snaps may be discarded. As explained, a framework may operate in an automated manner and/or in a semi-automated manner. For example, consider an approach where snap candidates are assessed and snap actions performed for a number of assessed snap candidates, according to one or more criteria. As explained, a framework may provide for rendering of one or more GUIs to a display where user interaction may provide for decision-making as to one or more actions.

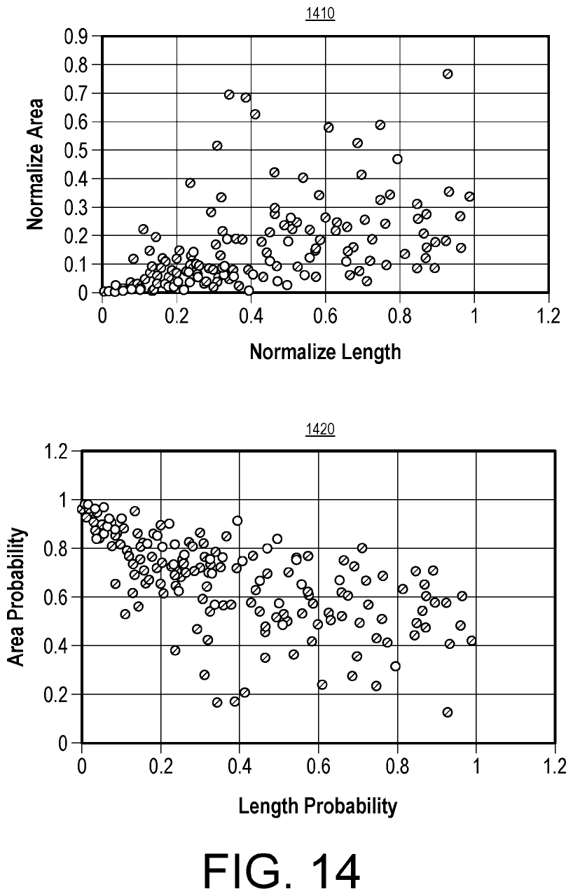

FIG. 14 shows example plots 1410 and 1420 for normalized area versus normalized length and area probability versus length probability, respectively. As shown, for each admissible snapping pair, the length and area measures of the plot 1410 may be transformed into probabilities of the plot 1420.

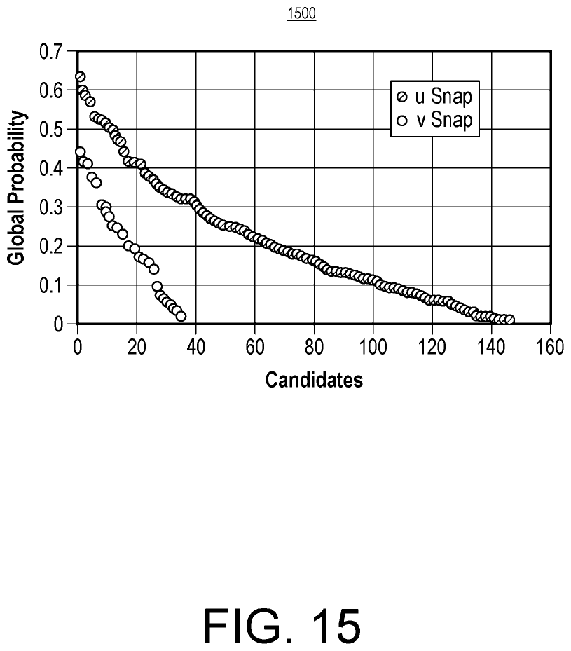

FIG. 15 shows an example plot 1500 of global probability versus candidate index for u-coordinate direction snapping and v-coordinate direction snapping. The plot 1500 may be generated using information from the plots 1410 and 1420 such that a result shows differences between u snap and v snap on a given model. As shown, candidates may be ranked to generate a ranked set of candidates (e.g., individual pairs of discontinuities) for projections in one or two directions. As an example, a framework may provide for recommending and/or performing one or more actions according to one or more rankings.

As to repair candidates and ranking thereof, as an example, a framework may provide for repair detection on a fault pair in a manner akin to that as for snapping, for example, at the difference that the virtual contact line has at least one node inside of a fault (e.g., consider inside the fault A). As an example, a framework may discard some cases to be candidates. For instance, if a virtual contact line is made of several distinct components, a framework may discard such a potential snap. As an example, nodes of a virtual truncation line which are not already in a fault (e.g., in the fault A) may be projected on the tiploop of that fault (e.g., the fault A), as may be performed for a snaping operation. As an example, a framework may perform ranking as to repair actions in a manner akin to how ranking is performed for snap actions.

As explained, a framework may provide for assessing interpretations as to one or more actions. As to a merge action, one or more parameters may be utilized, which may include distance between interpretation points of two sets of points that may be considered distinct. As explained, such a distance may be relative and/or based on one or more physical characteristics (e.g., resolution of seismic data, quality of seismic data, etc.). As an example, a distance may be related to a machine learning-based interpretation process. As to a snap action, it may be assessed and/or implemented to ensure contact between two separate discontinuities (e.g., faults, fractures, etc.). For example, to ensure contact, a snap action may provide for extending a tiploop or discontinuity perimeter to another discontinuity and/or beyond (e.g., at least in part through) another discontinuity. As to a repair action, it may provide for improving a relationship between two discontinuities where contact already exists.

As an example, a geometric representation of a discontinuity or geometric representations of multiple discontinuities may be generated and utilized in a 3D model that may be suitable for use in geomechanics, fluid flow, etc., workflows. As an example, a geometric representation may include information for transitioning from a lower dimension to a higher dimension and/or from a higher dimension to a lower dimension. For example, consider transitions from 2D (e.g., or 2.5D) and/or from 3D to 2D (e.g., or 2.5D). Such flexibility may provide for assessing, editing, revising, etc., one or more types of models. As an example, geometric representations of discontinuities may be provided in table form, for example, as a data structure that may be accessible to a simulator (e.g., for matrix computations, visualizations, etc.). As explained, geometric representations of discontinuities may be provided as implicit representations, which may, for example, be made explicit, depending on workflow specifics, etc. For example, an implicit representation may be utilized to generate a 3D explicit representation that may be incorporated into a 3D grid where, as appropriate, grid revision, grid refinement, etc., may be performed to make a discontinuity an integral part of the 3D grid. However, as explained, various tasks may be performed more efficiently using an implicit representation that may be flexible and more readily amenable to revision, particularly in a real-time or near real-time manner that may involve human interaction using a GUI, etc.

As explained, a subsurface environment may include various discontinuities where some uncertainty may exist as to whether or not they are discrete and/or intersecting. As explained, a framework may provide for expediting one or more workflows that may reduce such uncertainty.

As explained, one or more machine learning techniques may be utilized by a framework, frameworks, etc. As to types of machine learning (ML) models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley Al Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO. AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUS (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, one or more features of the KERAS library may be utilized. The KERAS library is an open-source library that provides a Python interface for artificial neural networks (ANNs). The KERAS library can act as an interface for the TENSORFLOW library.

As an example, a device may utilize TENSORFLOW LITE (TFL) or another type of lightweight framework. TFL is a set of tools that enables on-device machine learning where models may run on mobile, embedded, and loT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). TFL includes multiple platform support, covering ANDROID and iOS devices, embedded LINUX, and microcontrollers. TLF provides diverse language support, which includes JAVA, SWIFT, Objective-C, C++, and PYTHON. TFL provides high performance, with hardware acceleration and model optimization. As an example, one or more machine learning tasks may include, for example, classification, regression, object detection, pose estimation, question answering, text classification, etc., on one or more of multiple platforms.

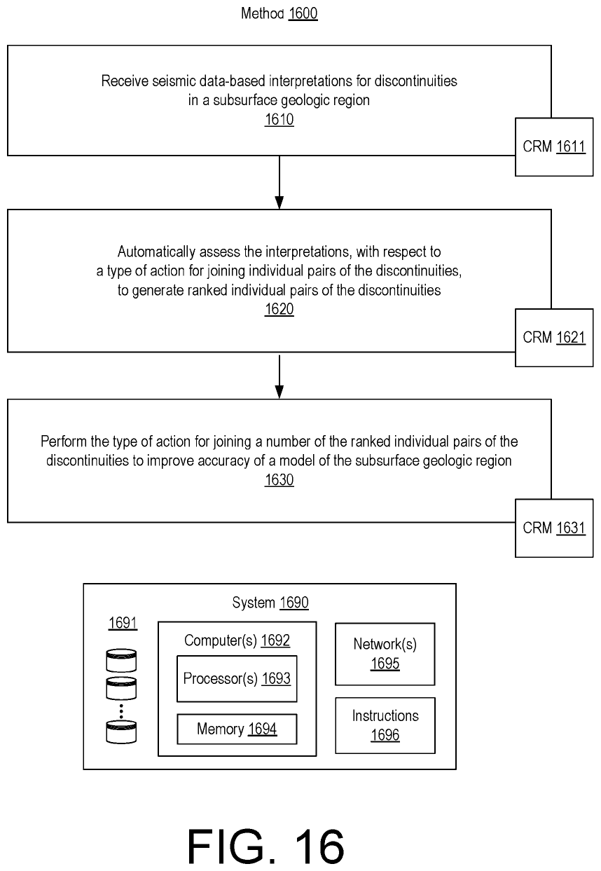

FIG. 16 shows an example of a method 1600 and an example of a system 1690. As shown, the method 1600 can include a reception block 1610 for receiving seismic data-based interpretations for discontinuities in a subsurface geologic region; an assessment block 1620 for automatically assessing the interpretations, with respect to a type of action for joining individual pairs of the discontinuities, to generate ranked individual pairs of the discontinuities; and a performance block 1630 for performing the type of action for joining a number of the ranked individual pairs of the discontinuities to improve accuracy of a model of the subsurface geologic region.

The method 1600 is shown in FIG. 16 in association with various computer-readable media (CRM) blocks 1611, 1621, and 1631. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 1600. As an example, a computer-readable medium (CRM) may be a computer-readable storage medium that is non-transitory and that is not a carrier wave. As an example, one or more of the blocks 1611, 1621, and 1631 may be in the form processor-executable instructions.

In the example of FIG. 16, the system 1690 includes one or more information storage devices 1691, one or more computers 1692, one or more networks 1695 and instructions 1696. As to the one or more computers 1692, each computer may include one or more processors (e.g., or processing cores) 1693 and memory 1694 for storing the instructions 1696, for example, executable by at least one of the one or more processors 1693 (see, e.g., the blocks 1611, 1621, and 1631). As an example, a computer may include one or more network interfaces (e.g., wired or wireless), one or more graphics cards, a display interface (e.g., wired or wireless), etc.

As an example, a method can include receiving seismic data-based interpretations for discontinuities in a subsurface geologic region; automatically assessing the interpretations, with respect to a type of action for joining individual pairs of the discontinuities, to generate ranked individual pairs of the discontinuities; and performing the type of action for joining a number of the ranked individual pairs of the discontinuities to improve accuracy of a model of the subsurface geologic region.

As an example, a type of action can be a merge action that merges an individual pair of discontinuities to form a single discontinuity. In such an example, a method may include assessing that includes determining a cost metric value for each of a number of individual pairs of discontinuities and generating ranked individual pairs based at least in part thereon. As an example, a method may include assessing that includes determining an angle metric value for each of a number of individual pairs of discontinuities and generating ranked individual pairs based at least in part thereon. As an example, a method may include assessing that includes determining a cost metric value and an angle metric value for each of a number of individual pairs of discontinuities and generating ranked individual pairs based at least in part thereon.

As an example, a type of action can include a snap action that snaps a first discontinuity of an individual pair to a second discontinuity of the individual pair. In such an example, a method may include assessing that includes projecting one of the discontinuities to a plane and determining a normalized length in the plane and/or projecting one of the discontinuities to a plane and determining a normalized area in the plane. As an example, a method may include projecting one of a pair of discontinuities to a plane and determining a normalized length and a normalized area in the plane. In such an example, the method may include generating ranked individual pairs based at least in part on the normalized length and the normalized area. In such an example, the ranked individual pairs may correspond to the snap action being performed in one of two different directions. As an example, ranked individual pairs may include a ranking of individual pairs for a snap action being performed in one direction and a ranking of individual pairs for a snap action being performed in another, different direction.

As an example, a type of action may be a repair action that adds virtual interpretation points to join a first discontinuity of an individual pair to a second discontinuity of the individual pair. In such an example, the pair may already be in contact, however, with contact that may be possibly improved. As explained, two discontinuities may be in contact over a particular region where actual contact may be over a larger region. As explained, a repair action may provide for joining two discontinuities over a larger region (e.g., joining in one or more regions where contact does not already exist, etc.).

As an example, a method may provide for automatically assessing that includes representing each of a number of discontinuities implicitly. In such an approach, one or more computations, renderings, integrations into another model, etc., may be performed more expeditiously. As explained, an implicit representation may utilize a 2D geometric representation with an associated height map and, for example, an associated tiploop attribute. As explained, a tiploop may be defined using tips of a discontinuity where, for example, a height map may be defined within the tiploop, on the tiploop and outside of the tiploop. By having a representation of a discontinuity that already accounts for the possibility of the discontinuity being revised to alter at least a portion of its perimeter (e.g., via a snap action, a repair action, etc.), such a revision may be assessed and/or performed more expeditiously, for example, in a real-time or near real-time manner that may provide for GUI interactions with responsive rendering whereby a user does not experience substantial latency that may otherwise impede the user's ability to focus, flow, etc. In such an approach, a user may be able to handle making model improvements with less boredom (e.g., waiting), stress, etc. As an example, when a user thinks an action will improve a model (e.g., by the user's own recognition and/or by a provided assessment, ranking, etc.), the user may call for implementation of that action where a framework may provide an immediate response thereto via rendering of a visualization to a display with minimal latency. Hence, in such an example, the time between a user's decision and a visible result may be minimal. Such an approach may conserve time such that a user may process a larger number of possible actions in a lesser amount of time, which may help to improve model accuracy and one or more subsequent workflows (e.g., simulation, etc.).

As explained, a method may include automatically assessing that includes representing each of a number of discontinuities using a corresponding height map. In such an approach, the corresponding height map may be defined at least in part outside of a discontinuity tiploop. As explained, a discontinuity tiploop may be defined using tips of a discontinuity (e.g., consider fault tips of a fault, fracture tips of a fracture, etc.).

As explained, interpretations may be or include machine learning-based interpretations. As explained, a machine learning-based approach to interpretations may generate more interpretations in a given amount of time than a human interpreter. As explained, a framework may provide for handling a relatively large number of interpretations in an expeditious manner, which may thereby help to leverage machine learning-based interpretation capabilities. As explained, a framework may provide for generation of feedback that may be utilized to improve a machine learning-based interpretation process. Hence, a framework may be part of or operatively coupled to a machine learning-based interpretation framework.

As an example, discontinuities may include one or more of faults and fractures; noting that one or more other types of discontinuities may be handled by a framework.

As an example, a system can include a processor; a memory operatively coupled to the processor; and processor-executable instructions stored in the memory and executable to instruct the system to: receive seismic data-based interpretations for discontinuities in a subsurface geologic region; automatically assess the interpretations, with respect to a type of action for joining individual pairs of the discontinuities, to generate ranked individual pairs of the discontinuities; and perform the type of action for joining a number of the ranked individual pairs of the discontinuities to improve accuracy of a model of the subsurface geologic region.

As an example, one or more computer-readable storage media can include processor-executable instructions executable by a system to instruct the system to: receive seismic data-based interpretations for discontinuities in a subsurface geologic region; automatically assess the interpretations, with respect to a type of action for joining individual pairs of the discontinuities, to generate ranked individual pairs of the discontinuities; and perform the type of action for joining a number of the ranked individual pairs of the discontinuities to improve accuracy of a model of the subsurface geologic region.

As an example, a computer program product can include one or more computer-readable storage media that can include processor-executable instructions to instruct a computing system to perform one or more methods and/or one or more portions of a method.

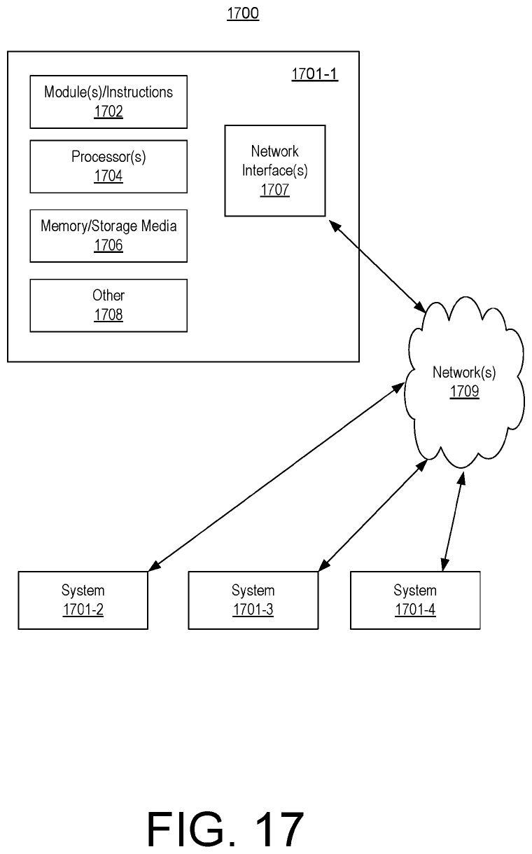

In some embodiments, a method or methods may be executed by a computing system. FIG. 17 shows an example of a system 1700 that can include one or more computing systems 1701-1, 1701-2, 1701-3 and 1701-4, which may be operatively coupled via one or more networks 1709, which may include wired and/or wireless networks.

As an example, a system can include an individual computer system or an arrangement of distributed computer systems. In the example of FIG. 17, the computer system 1701-1 can include one or more modules 1702, which may be or include processor-executable instructions, for example, executable to perform various tasks (e.g., receiving information, requesting information, processing information, simulation, outputting information, etc.).

As an example, a module may be executed independently, or in coordination with, one or more processors 1704, which is (or are) operatively coupled to one or more storage media 1706 (e.g., via wire, wirelessly, etc.). As an example, one or more of the one or more processors 1704 can be operatively coupled to at least one of one or more network interfaces 1707; noting that one or more other components 1708 may also be included. In such an example, the computer system 1701-1 can transmit and/or receive information, for example, via the one or more networks 1709 (e.g., consider one or more of the Internet, a private network, a cellular network, a satellite network, etc.).

As an example, the computer system 1701-1 may receive from and/or transmit information to one or more other devices, which may be or include, for example, one or more of the computer systems 1701-2, etc. A device may be located in a physical location that differs from that of the computer system 1701-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1706 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution. As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Of course, many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

Many examples of equations and mathematical expressions have been provided in this disclosure. But those with skill in the art will appreciate that variations of these expressions and equations, alternative forms of these expressions and equations, and related expressions and equations that can be derived from the example equations and expressions provided herein may also be successfully used to perform the methods, techniques, and workflows related to the embodiments disclosed herein.

While any discussion of or citation to related art in this disclosure may or may not include some prior art references, applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to utilize the invention and various embodiments with various modifications as are suited to the particular use contemplated.

In some embodiments, the multi-dimensional region of interest is selected from the group consisting of a subterranean region, human tissue, plant tissue, animal tissue, solid volumes, substantially solid volumes, volumes of liquid, volumes of gas, volumes of plasma, and volumes of space near and/or outside the atmosphere of a planet, asteroid, comet, moon, or other body.

In some embodiments, the multi-dimensional region of interest includes one or more volume types selected from the group consisting of a subterranean region, human tissue, plant tissue, animal tissue, solid volumes, substantially solid volumes, volumes of liquid, volumes of air, volumes of plasma, and volumes of space near and/or or outside the atmosphere of a planet, asteroid, comet, moon, or other body.

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving seismic data-based interpretations for discontinuities in a subsurface geologic region;
automatically assessing the interpretations, with respect to a type of action for joining individual pairs of the discontinuities, to generate ranked individual pairs of the discontinuities; and
performing the type of action for joining a number of the ranked individual pairs of the discontinuities to improve accuracy of a model of the subsurface geologic region.

2. The method of claim 1, wherein the type of action includes a merge action that merges an individual pair of discontinuities to form a single discontinuity.

3. The method of claim 2, wherein the assessing includes determining a cost metric value for each of the individual pairs of discontinuities and generating the ranked individual pairs based at least in part thereon.

4. The method of claim 2, wherein the assessing includes determining an angle metric value for each of the individual pairs of discontinuities and generating the ranked individual pairs based at least in part thereon.

5. The method of claim 2, wherein the assessing includes determining a cost metric value and an angle metric value for each of the individual pairs of discontinuities and generating the ranked individual pairs based at least in part thereon.

6. The method of claim 1, wherein the type of action includes a snap action that snaps a first discontinuity of an individual pair to a second discontinuity of the individual pair.

7. The method of claim 6, wherein the assessing includes projecting one of the discontinuities to a plane and determining a normalized length in the plane.

8. The method of claim 6, wherein the assessing includes projecting one of the discontinuities to a plane and determining a normalized area in the plane.

9. The method of claim 6, wherein the assessing includes projecting one of the discontinuities to a plane and determining a normalized length and a normalized area in the plane.

10. The method of claim 9, comprising generating the ranked individual pairs based at least in part on the normalized length and the normalized area.

11. The method of claim 10, wherein the ranked individual pairs correspond to the snap action being performed in one of two different directions.

12. The method of claim 10, wherein the ranked individual pairs include a ranking of individual pairs for the snap action being performed in one direction and a ranking of individual pairs for the snap action being performed in another, different direction.

13. The method of claim 1, wherein the type of action includes a repair action that adds virtual interpretation points to join a first discontinuity of an individual pair to a second discontinuity of the individual pair.

14. The method of claim 1, wherein the automatically assessing includes representing each of the discontinuities implicitly.

15. The method of claim 1, wherein the automatically assessing includes representing each of the discontinuities using a corresponding height map.

16. The method of claim 15, wherein the corresponding height map is defined at least in part outside of a discontinuity tiploop.

17. The method of claim 1, wherein the interpretations include machine learning-based interpretations.

18. The method of claim 1, wherein the discontinuities include one or more of faults and fractures.

19. A system comprising:
a processor;
a memory operatively coupled to the processor; and
processor-executable instructions stored in the memory and executable to instruct the system to:
receive seismic data-based interpretations for discontinuities in a subsurface geologic region;
automatically assess the interpretations, with respect to a type of action for joining individual pairs of the discontinuities, to generate ranked individual pairs of the discontinuities; and
perform the type of action for joining a number of the ranked individual pairs of the discontinuities to improve accuracy of a model of the subsurface geologic region.

20. One or more computer-readable storage media comprising processor-executable instructions executable by a system to instruct the system to:
receive seismic data-based interpretations for discontinuities in a subsurface geologic region;
automatically assess the interpretations, with respect to a type of action for joining individual pairs of the discontinuities, to generate ranked individual pairs of the discontinuities; and
perform the type of action for joining a number of the ranked individual pairs of the discontinuities to improve accuracy of a model of the subsurface geologic region.
